(19) United States
(12) Patent Application Publication
(10) Pub. No.: US 2021/0119263 A1
(43) Pub. Date: Apr. 22, 2021

(54) NONAQUEOUS ELECTROLYTE SECONDARY BATTERY

(71) Applicant: SANYO Electric Co., Ltd., Daito-shi, Osaka (JP)

(72) Inventors: Koichi Kusagawa, Osaka (JP); Junichi Sugaya, Osaka (JP); Atsushi Mizawa, Hyogo (JP)

(73) Assignee: SANYO Electric Co., Ltd., Daito-shi, Osaka (JP)

(21) Appl. No.: 16/496,259

(22) PCT Filed: Mar. 15, 2018
(86) PCT No.: PCT/JP2018/010114

§ 371 Date: Sep. 20, 2019

(30) Foreign Application Priority Data
Mar. 24, 2017 (JP) 2017-058999

(51) Int. Cl. H01M 10/0587; H01M 10/0525; H01M 50/533

(52) U.S. Cl. CPC H01M 10/0587; H01M 50/533; H01M 10/0525

(57) ABSTRACT

A battery having a positive electrode lead connected to a radial-direction intermediate position of the electrode body, and a negative electrode lead connected to a winding start end. In a region other than a first region defined by the outermost circumference of the negative electrode and two straight lines extending from a winding central axis of the electrode body through two points which are outside from two circumference-direction ends of the negative electrode lead by an angle of 10° with respect to the winding central axis and a second region defined by two straight lines in contact with two circumference-direction ends of the positive electrode lead drawn in parallel to a straight line between a circumference-direction center of the positive electrode lead and the winding central axis, the outermost circumference of the negative electrode, and the innermost circumference thereof, a winding start front end of the positive electrode is disposed.

### TECHNICAL FIELD

The present disclosure relates to a nonaqueous electrolyte secondary battery.

### BACKGROUND ART

PTL 1 has disclosed a battery in which in a cylindrical exterior package can made of iron or an iron alloy, an electrolyte solution and a winding electrode body formed by winding a positive electrode and a negative electrode with at least one separator interposed therebetween are received. It has been described that in this battery, two negative electrode leads are fitted to a winding start end and a winding finish end of the negative electrode located, respectively, at an inner circumference side and an outer circumference side of the electrode body, and those negative electrode leads are connected to a bottom portion of the exterior package can.

### CITATION LIST

### Patent Literature

PTL 1: Japanese Published Unexamined Patent Application No. 2007-273258

### SUMMARY OF INVENTION

### Technical Problem

As is the winding electrode body described in PTL 1, when a negative electrode lead is disposed at an inner circumference side of an electrode body, since a positive electrode and a negative electrode are repeatedly wound at a radial-direction outer side, stress is generated in the electrode body due to an inner circumference-side negative electrode tab, and as a result, electrode plate deformation may occur in some cases.

Since the positive electrode is formed by cutting a long web having two surfaces on which positive electrode active material layers are formed, at a cut surface thereof, a core material of the positive electrode is exposed between the two active material layers provided on the front and the rear surfaces. Hence, when a winding start front end of the positive electrode is located at a portion at which the electrode plate deformation described above occurs, internal short circuit may occur between the core material of the positive electrode and the negative electrode in some cases. The internal short circuit described above may also occur by the electrode plate deformation generated due to a positive electrode lead.

An object of the present disclosure is to provide a nonaqueous electrolyte secondary battery which can suppress, in a winding type electrode body, the generation of internal short circuit between a negative electrode plate and a winding start front end of a positive electrode plate due to electrode plate deformation at positions corresponding to a positive electrode lead and a negative electrode lead.

### Solution to Problem

A nonaqueous electrolyte secondary battery according to the present disclosure comprises: an electrode body in which a positive electrode plate having a positive electrode lead and a negative electrode plate having a negative electrode lead are wound in a spiral shape with at least one separator interposed therebetween. The positive electrode lead is connected to the positive electrode plate at a radial-direction intermediate position of the electrode body, and the negative electrode lead is connected to the negative electrode plate at a winding start end thereof. In a radial-direction cross-section of the electrode body, when a region defined by the outermost circumference of the negative electrode plate and two straight lines extending from a winding central axis of the electrode body through two points which are apart outside from two circumference-direction ends of the negative electrode lead by an angle of 10° with respect to the winding central axis is regarded as a first region, and when a region defined by two straight lines in contact with two circumference-direction ends of the positive electrode lead each drawn in parallel to a straight line between a circumference-direction center of the positive electrode lead and the winding central axis, the outermost circumference of the negative electrode plate, and the innermost circumference thereof is regarded as a second region, a winding start front end of the positive electrode plate is disposed in a region other than the first and the second regions.

### Advantageous Effects of Invention

According to the nonaqueous electrolyte secondary battery of the present disclosure, in the electrode body, in the region other than the first region in which the electrode plate deformation may occur due to the negative electrode lead and the second region in which the electrode plate deformation may occur due to the positive electrode lead, since the winding start front end of the positive electrode plate is disposed, the internal short circuit caused by the electrode plate deformation due to the positive electrode lead and the negative electrode lead can be effectively suppressed.

### BRIEF DESCRIPTION OF DRAWINGS

FIG. 1 is an axial-direction cross-sectional view of a nonaqueous electrolyte secondary battery which is one example of an embodiment.

FIG. 2 is a perspective view of an electrode body which is one example of the embodiment.

FIG. 3 is a front view showing a developed state of a positive electrode plate and a negative electrode plate forming the electrode body which is one example of the embodiment.

FIG. 4 is a radial-direction cross-sectional view of the vicinity of a winding core of the electrode body which is one example of the embodiment.

FIG. 5 is a radial-direction cross-sectional view of a first and a second region in which electrode plate deformation may occur in the electrode body.

FIG. 6A is a view showing a positional relationship among a negative electrode lead, a positive electrode lead, and a winding start front end of a positive electrode plate in a radial-direction cross-section of an electrode body in each of Examples 1 to 6.

FIG. 6B is a view showing a positional relationship among a negative electrode lead, a positive electrode lead, and a winding start front end of a positive electrode plate in a radial-direction cross-section of an electrode body in each of Examples 7 to 12.

### DESCRIPTION OF EMBODIMENT

Hereinafter, an embodiment according to the present invention will be described in detail with reference to the attached drawings. In the following description, particular shapes, materials, numeral values, directions, and the like are described by way of example to facilitate the understanding of the present invention, and those may be appropriately changed in accordance with the application, the object, the specification, and the like. In addition, the following term “approximately” is used to indicate, for example, besides “exactly the same”, “substantially the same”. Furthermore, in the following description, when embodiments, modified examples, and the like are included, the use of characteristic portions thereof in appropriate combination has been taken into consideration from the beginning.

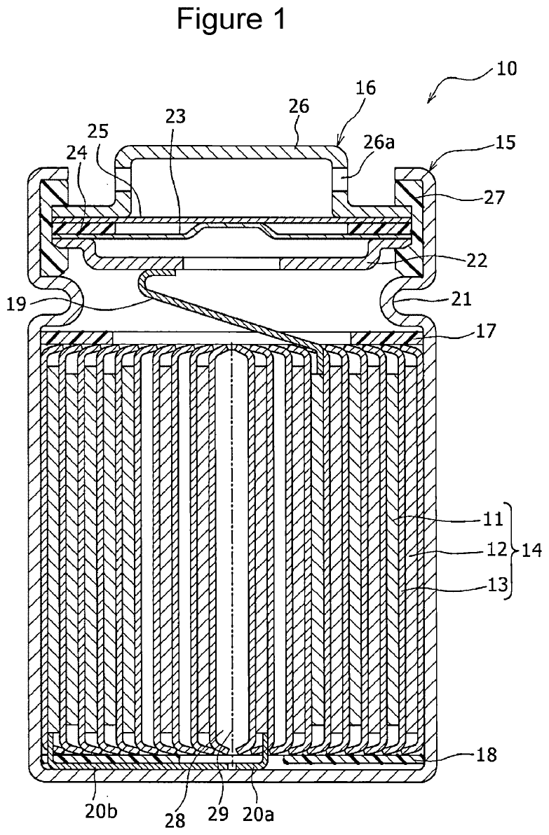

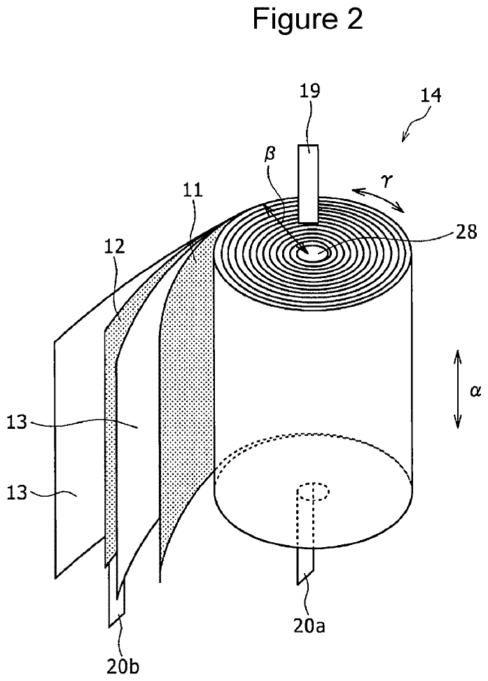

FIG. 1 is a cross-sectional view of a nonaqueous electrolyte secondary battery 10. FIG. 2 is a perspective view of an electrode body 14 forming the nonaqueous electrolyte secondary battery 10. As shown in FIGS. 1 and 2 by way of example, the nonaqueous electrolyte secondary battery 10 includes the winding type electrode body 14 and a nonaqueous electrolyte (not shown). The winding type electrode body 14 includes a positive electrode plate 11, a negative electrode plate 12, and separators 13, and the positive electrode plate 11 and the negative electrode plate 12 are wound in a spiral shape with the separators 13 interposed therebetween. Hereinafter, one axial direction of the electrode body 14 and the other axial direction thereof may be called “up” and “down”, respectively, in some cases. The nonaqueous electrolyte contains a nonaqueous solvent and an electrolyte salt dissolved in the nonaqueous solvent. The nonaqueous electrolyte is not limited to a liquid electrolyte and may be a solid electrolyte using a gel polymer or the like.

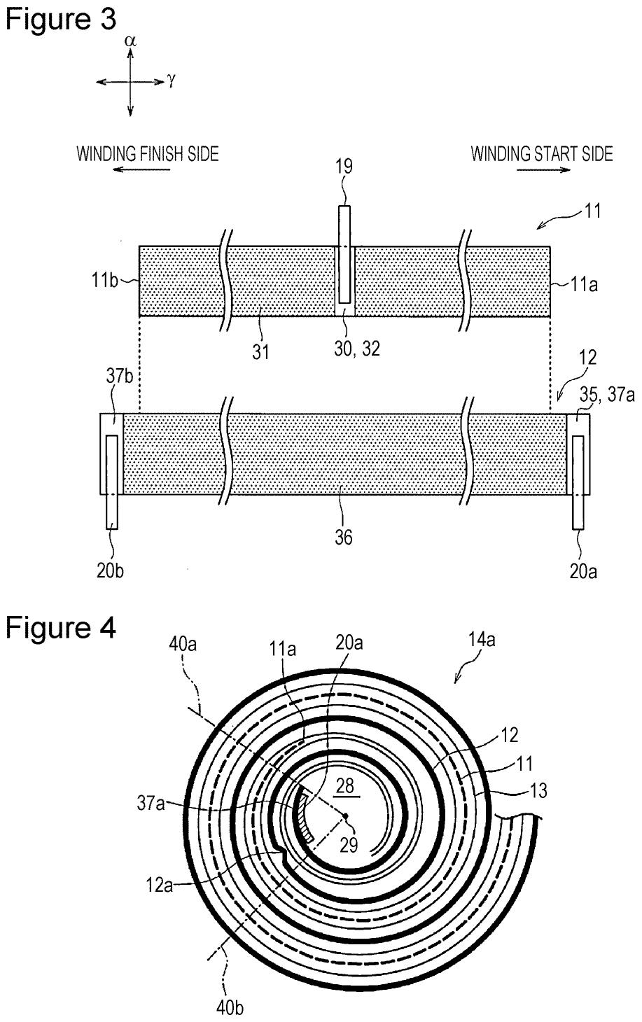

The positive electrode plate 11 includes a belt-shaped positive electrode collector 30 (see FIG. 3) and a positive electrode lead 19 bonded to the collector described above. The positive electrode lead 19 is an electrically conductive member to electrically connect the positive electrode collector 30 to a positive electrode terminal and is extended from an upper end of an electrode group in an axial direction α (upper side) of the electrode body 14. In this case, the electrode group indicates a portion of the electrode body 14 other than the individual leads. The positive electrode lead 19 is provided, for example, at an approximately central portion of the electrode body 14 in a radial direction β.

The negative electrode plate 12 includes a belt-shaped negative electrode collector 35 (see FIG. 3 which will be described later) and two negative electrode leads 20a and 20b connected to the collector described above. The negative electrode leads 20a and 20b are each an electrically conductive member which electrically connects the negative electrode collector 35 to a negative electrode terminal and are extended from a lower end of the electrode group in the axial direction α (lower side). For example, the negative electrode lead 20a is provided at a winding start end of the electrode body 14, and the negative electrode lead 20b is provided at a winding finish end thereof. An inner circumference side or a radial-direction inner side of the electrode body 14 is called a winding core side, and an outer circumference side or a radial-direction outer side may also be called a winding outer side in some cases.

The positive electrode lead 19 and the negative electrode leads 20a and 20b are each a belt-shaped electrically conductive member having a thickness larger than that of the collector. The thickness of the lead is, for example, 3 to 30 times the thickness of the collector and is, in general, 50 to 500 μm. Although a material forming each lead is not particularly limited, the positive electrode lead 19 is preferably formed of a metal containing aluminum as a primary component, and the negative electrode leads 20a and 20b are each preferably formed of a metal containing nickel or copper as a primary component. In addition, the number of the leads, the arrangement thereof, and the like are not particularly limited. For example, the negative electrode lead may only be fitted to a winding start end of the negative electrode plate 12.

In the example shown in FIG. 1, by a case main body 15 and a sealing body 16, a metal-made battery case which receives the electrode body 14 and the nonaqueous electrolyte is formed. On the top and the bottom of the electrode body 14, insulating plates 17 and 18 are provided, respectively. The positive electrode lead 19 is extended to a sealing body 16 side through a through-hole of the insulating plate 17 and is welded to a bottom surface of a filter 22 which is a bottom plate of the sealing body 16. In the nonaqueous electrolyte secondary battery 10, a cap 26 which is a top plate of the sealing body 16 electrically connected to the filter 22 is used as the positive electrode terminal. On the other hand, the negative electrode lead 20a passing through a through-hole of the insulating plate 18 and the negative electrode lead 20b passing along an outside of the insulating plate 18 are extended to a bottom portion side of the case main body 15 and are then welded to an inside surface of the bottom portion of the case main body 15. In the nonaqueous electrolyte secondary battery 10, the case main body 15 is used as the negative electrode terminal.

As described above, the electrode body 14 has a winding structure in which the positive electrode plate 11 and the negative electrode plate 12 are wound in a spiral shape with the separators 13 interposed therebetween. The positive electrode plate 11, the negative electrode plate 12, and the separators 13 are each formed to have a belt shape and are spirally wound so as to be alternately laminated to each other in the radial direction β of the electrode body 14. In the electrode body 14, the longitudinal direction of each electrode is a winding direction γ, and the width direction of each electrode is an axial direction α. In this embodiment, in a winding core of the electrode body 14, a space 28 is formed. The electrode body 14 is wound in a spiral shape around a winding central axis 29 extending in the axis direction at the center of the space 28. In this case, the winding central axis 29 is a central axis extending in the axis direction at a radial-direction central position of the space 28 and is a winding central axis of the electrode body 14.

The case main body 15 is a metal-made bottom-closed cylindrical container. Between the case main body 15 and the sealing body 16, a gasket 27 is provided, so that the air-tightness in the battery case is secured. The case main body 15 has a protruding portion 21 which is formed, for example, by pressing a side surface portion from the outside and which supports the sealing body 16. The protruding portion 21 is preferably formed to have a ring shape along the circumference direction of the case main body 15, and the upper surface of the protruding portion 21 supports the sealing body 16.

The sealing body 16 includes the filter 22, a lower valve 23, an insulating member 24, an upper valve 25, and the cap 26, which are laminated sequentially from an electrode body 14 side. The individual members forming the sealing body 16 each have, for example, a circular shape or a ring shape and are electrically connected to each other except for the insulating member 24. The lower valve 23 and the upper valve 25 are connected to each other at central portions thereof, and between the peripheral portions thereof, the insulating member 24 is provided. When the internal pressure of the battery is increased by abnormal heat generation, for example, the lower valve 23 is fractured, and as a result, the upper valve 25 is swelled to a cap 26 side and is separated from the lower valve 23, so that the electrical connection between the above two valves is disconnected. When the internal pressure is further increased, the upper valve 25 is fractured, and gases are exhausted from an opening portion 26a of the cap 26.

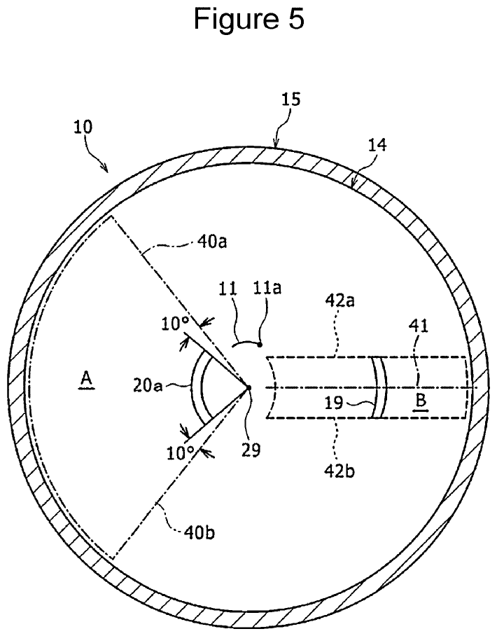

Hereinafter, with reference to FIGS. 3 to 6, the electrode body 14 will be described in detail. FIG. 3 is a front view of the positive electrode plate 11 and the negative electrode plate 12 forming the electrode body 14. In FIG. 3, a developed state of each electrode is shown, and the right side and the left side of the plane indicate a winding start side and a winding finish side of the electrode body 14, respectively. FIG. 4 is a cross-sectional view in the case in which the vicinity of the winding core of the electrode body 14 is cut in the radial direction β.

As shown in FIGS. 3 and 4 by way of example, in the electrode body 14, in order to prevent the precipitation of lithium on the negative electrode plate 12, the negative electrode plate 12 is formed larger than the positive electrode plate 11. In particular, the width of the negative electrode plate 12 in the axis direction α is larger than that of the positive electrode plate 11. In addition, the length of the negative electrode plate 12 in the longitudinal direction is larger than that of the positive electrode plate 11. Accordingly, when winding is performed to form the electrode body 14, a portion at which a positive electrode active material layer 31 of the positive electrode plate 11 is formed is at least disposed to face a portion at which a negative electrode active material layer 36 of the negative electrode plate 12 is formed with the separator 13 interposed therebetween.

The positive electrode plate 11 includes the belt-shaped positive electrode collector 30 and the positive electrode active material layer 31 formed on the collector described above. In this embodiment, the positive electrode active material layers 31 are formed on two surfaces of the positive electrode collector 30. For the positive electrode collector 30, for example, foil of a metal, such as aluminum, or a film having a surface layer formed of the metal mentioned above may be used. A preferable positive electrode collector 30 is foil of a metal containing aluminum or an aluminum alloy as a primary component. The thickness of the positive electrode collector 30 is, for example, 10 to 30 μm.

The positive electrode active material layers 31 are preferably formed over the entire two surfaces of the positive electrode collector 30 except for an un-covered portion 32 which will be described later. The positive electrode active material layer 31 preferably contains a positive electrode active material, an electrically conductive agent, and a binder. The positive electrode plate 11 is formed by applying a positive electrode mixture slurry containing the positive electrode active material, the electrically conductive agent, the binder, and a solvent, such as N-methyl-2-pyrrolidone (NMP) on the two surfaces of the positive electrode collector 30, followed by drying and rolling.

As the positive electrode active material, for example, there may be mentioned a lithium transition metal oxide containing a transition metal element, such as Co, Mn, or Ni. Although the lithium transition metal oxide is not particularly limited, a composite oxide represented by a general formula of Li₁₊ₓMO₂ (in the formula, −0.2<x≤0.2, and M includes at least one of Ni, Co, Mn, and Al) is preferable.

As an example of the electrically conductive agent described above, for example, there may be mentioned a carbon material, such as carbon black (CB), acetylene black (AB), Ketjen black, or graphite. As an example of the binder described above, for example, there may be mentioned a fluorine-based resin, such as a polytetrafluoroethylene (PTFE) or a poly(vinylidene fluoride) (PVdF), a polyacrylonitrile (PAN), a polyimide (PI), an acryl-based resin, or a polyolefin-based resin. In addition, those resins mentioned above each may be used together with a carboxymethyl cellulose (CMC) or its salt, a polyethylene oxide (PEO), or the like. Those resins may be used alone, or at least two types thereof may be used in combination.

The positive electrode plate 11 has at least one un-covered portion 32 at which the surface of the metal forming the positive electrode collector 30 is exposed. The un-covered portion 32 is a portion to which the positive electrode lead 19 is connected and is a portion at which the surface of the positive electrode collector 30 is not covered with the positive electrode active material layer 31. The un-covered portion 32 is formed to have a width larger than that of the positive electrode lead 19. The un-covered portion 32 is preferably provided at two surfaces of the positive electrode plate 11 so as to be overlapped with each other in the thickness direction of the positive electrode plate 11. The positive electrode lead 19 is bonded to the un-covered portion 32, for example, by ultrasonic wave welding.

In the example shown in FIG. 3, at a central portion of the positive electrode plate 11 in the longitudinal direction, the un-covered portion 32 is provided over the entire width-direction length of the collector. Although the un-covered portion 32 may be formed at an end portion side of the positive electrode plate 11 in the longitudinal direction, in view of electricity collection property, the un-covered portion 32 is preferably provided at a position at which the distance from one end of the positive electrode plate 11 in the longitudinal direction is approximately equivalent to the distance from the other end thereof. Since the positive electrode lead 19 is connected to the un-covered portion 32 provided at the position as described above, when the positive electrode plate 11 is wound to form the electrode body 14, the positive electrode lead 19 is disposed at the central position of the electrode body 14 in the radial direction so as to protrude to an upper side from the end surface of the electrode body 14 in the axial direction. The un-covered portion 32 is formed, for example, by intermittent coating in which the positive electrode mixture slurry is not applied to a part of the positive electrode collector 30. In addition, the un-covered portion 32 may be formed to have a length from the upper end of the positive electrode plate 11 to a point not reaching the lower end thereof.

The negative electrode plate 12 includes the belt-shaped negative electrode collector 35 and the negative electrode active material layer 36 formed on the negative electrode collector described above. In this embodiment, the negative electrode active material layers 36 are formed on two surfaces of the negative electrode collector 35. For the negative electrode collector 35, for example, foil of a metal, such as copper, or a film having a surface layer formed of the metal mentioned above is used. The thickness of the negative electrode collector 35 is, for example, 5 to 30 μm.

The negative electrode active material layers 36 are preferably formed on the entire two surfaces of the negative electrode collector 35 except for un-covered portions 37a and 37b. The negative electrode active material layer 36 preferably contains a negative electrode active material and a binder. The negative electrode plate 12 is formed by applying a negative electrode mixture slurry containing the negative electrode active material, the binder, water, and the like on the two surfaces of the negative electrode collector 35, followed by drying and rolling.

The negative electrode active material is not particularly limited as long as being capable of reversibly occluding and releasing lithium ions, and for example, there may be used a carbon material, such as natural graphite or artificial graphite, a metal, such as Si or Sn, forming an alloy with lithium, or an alloy or a composite oxide, each of which contains the material mentioned above. For the binder contained in the negative electrode active material layer 36, for example, a resin similar to that used in the case of the positive electrode plate 11 may be used. When the negative electrode mixture slurry is prepared using an aqueous solvent, for example, a styrene-butadiene rubber (SBR), a CMC or its salt, a polyacrylic acid or its salt, or a poly(vinyl alcohol) may be used. Those compounds may be used alone, or at least two types thereof may be used in combination.

The negative electrode plate 12 has at least one un-covered portion 37a and at least one un-covered portion 37b at each of which the surface of the metal forming the negative electrode collector 35 is exposed. The un-covered portions 37a and 37b are portions to which the negative electrode leads 20a and 20b are connected, respectively, and are portions at each of which the surface of the negative electrode collector 35 is not covered with the negative electrode active material layer 36. The un-covered portions 37a and 37b each have an approximately rectangular shape in front view extending long in the width direction of the negative electrode plate 12 and are formed to have widths larger than those of the negative electrode leads 20a and 20b, respectively. The un-covered portions 37a are preferably formed at two surfaces of the negative electrode plate 12 so as to be overlapped with each other in the thickness direction of the negative electrode plate 12. The same configuration as described above may also be applied to the un-covered portion 37b.

In this embodiment, the negative electrode lead 20a is bonded to a surface of the negative electrode collector 35 facing an inner circumference side by ultrasonic wave welding or the like. One end portion (upper end) of the negative electrode lead 20a is disposed on the un-covered portion 37a, and the other end portion thereof is extended to a lower side from the lower end of the un-covered portion 37a.

In the example shown in FIG. 3, at the two ends (that is, the winding start end and the winding finish end) of the negative electrode plate 12 in the longitudinal direction, the un-covered portions 37a and 37b are respectively provided over the entire width-direction length of the collector. As described above, sine the negative electrode leads 20a and 20b are provided at the two ends of the negative electrode plate 12 in the longitudinal direction, the electricity collection property is improved. However, the arrangement of the negative electrode leads is not limited to that described above, and the negative electrode lead 20a may only be provided at the winding start end of the negative electrode plate 12. In this case, the un-covered portion 37b which is the winding finish end is preferably directly brought into contact with an inner circumference surface of the case main body 15. The un-covered portions are each provided, for example, by intermittent coating in which the negative electrode mixture slurry is not applied to a part of the negative electrode collector 35. In addition, the un-covered portions each may be formed to have a length from the lower end of the negative electrode plate 12 to a point not reaching the upper end thereof.

For the separator 13, a porous sheet having an ion permeability and an insulating property is used. As a concrete example of the porous sheet, for example, a fine pore thin film, a woven cloth, or a non-woven cloth may be mentioned. As a material of the separator 13, an olefin resin, such as a polyethylene or a polypropylene, is preferable. The thickness of the separator 13 is, for example, 10 to 50 μm. In accordance with the increase in capacity and power of the battery, the thickness of the separator 13 tends to be decreased. The separator 13 has, for example, a melting point of approximately 130° C. to 180° C.

The positive electrode plate 11, the negative electrode plate 12, and the separators 13, each of which has the structure described above, are wound in a spiral shape, so that the electrode body 14 is formed. The outermost circumference of the electrode body 14 is formed of the separator 13, and a winding finish end of the separator 13 is fixed by an insulating tape not shown. Accordingly, winding looseness of the electrode body 14 is not only prevented, but an outermost circumference side separator 13 or the like can also be prevented from being turned up when the electrode body 14 is inserted in the case main body 15. In addition, the insulating tape is preferably adhered to the outer circumference of the electrode body 14 by approximately one turn.

As shown in FIG. 4, the negative electrode plate 12 is wound earlier than the positive electrode plate 11, and the separator 13 is present between a positive electrode plate 11 and the negative electrode plate 12. The space 28 having an approximately cylindrical shape is formed at a winding core portion of the electrode body 14 to extend in the axial direction. Although the negative electrode lead 20a is disposed on a surface of the un-covered portion 37a provided at the winding start end of the negative electrode plate 12, the surface facing the radial-direction inner side of the electrode body 14, the negative electrode lead 20a may be disposed either on an inside surface or an outside surface of the un-covered portion 37a.

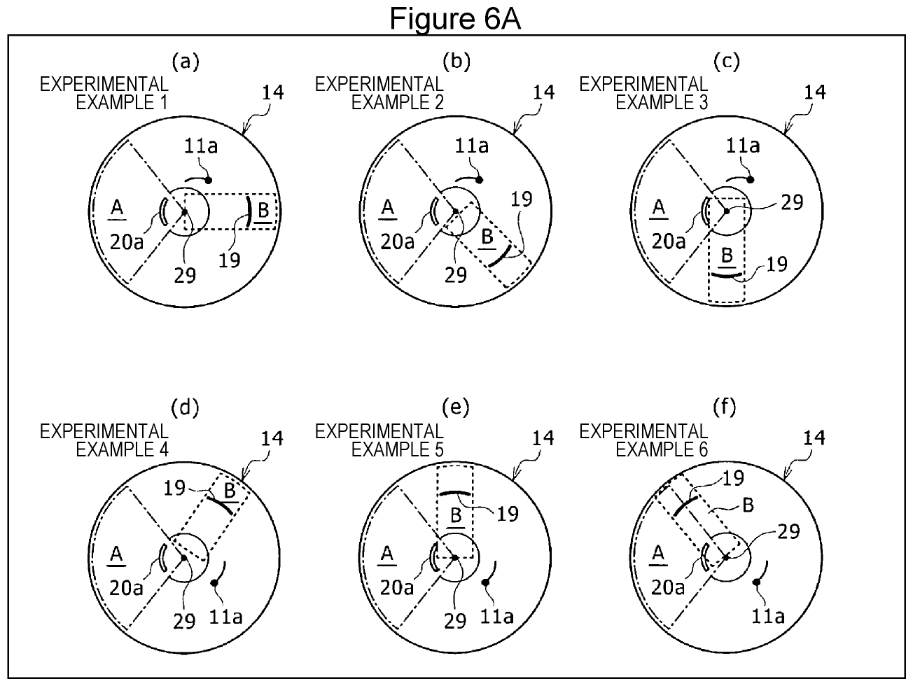

The negative electrode lead 20a provided at the winding start end of the negative electrode plate 12 has a larger plate thickness and a higher rigidity than those of the negative electrode collector 35, the negative electrode lead 20a is relatively not easily bent into an arc shape. Hence, in the electrode body 14, by the influence of the negative electrode lead 20a which is not fully bent into an arc shape, in a region corresponding to the radial-direction outer side of the negative electrode lead 20a, the internal pressure (or internal stress) tends to be increased. As a result, when charge/discharge of the nonaqueous electrolyte secondary battery 10 is repeatedly performed, since the electrode body 14 is expanded and contracted, the electrode plate deformation may be generated in the positive electrode plate 11 and/or the negative electrode plate 12 in some cases. FIG. 4 shows, in the negative electrode plate 12 located in the vicinity of an outer circumference side of the negative electrode lead 20a, an electrode plate deformation portion 12a deformed to locally swell to an inner circumference side. In addition, in FIG. 4, a region in which the electrode plate deformation is liable to occur by the influence of the negative electrode lead 20a disposed at the inner circumference side as described above is shown as a fan-shaped chain line region defined by two straight lines 40a and 40b extending from the winding central axis 29 in the radial direction. This region will be described in detail with reference to FIG. 5.

Since the positive electrode plate 11 is formed by cutting a long web having a front and a rear surface on each of which the positive electrode active material layer 31 is formed, at a winding start front end 11a of the positive electrode plate 11, the metal-made positive electrode collector 30 forming the positive electrode plate 11 is exposed between the positive electrode active material layers 31 provided on the front and the rear surfaces of the positive electrode collector 30. Hence, when the winding start front end 11a of the positive electrode plate 11 is located at the portion at which the electrode plate deformation occurs as described above, the positive electrode collector exposed at the winding start front end 11a and the negative electrode plate 12 may break the separator 13, so that internal short circuit may occur in some cases. This internal short circuit may also occur by the electrode plate deformation generated due to the positive electrode lead 19. In order to prevent or suppress the internal short circuit due to the electrode plate deformation as described above, in the positional relationship between the negative electrode lead 20a and the positive electrode lead 19, the winding start front end 11a of the positive electrode plate 11 is preferably disposed at a position at which the electrode plate deformation is not likely to occur. Next, with reference to FIG. 5, a preferable position of the winding start front end 11a of the positive electrode plate 11 will be described.

FIG. 5 is a radial-direction cross-sectional view of the nonaqueous electrolyte secondary battery 10 which shows a first region A and a second region B in each of which the electrode plate deformation may occur in the electrode body 14 in some cases.

As shown in FIG. 5, in the radial-direction cross-section of the electrode body 14, a region defined by the outermost circumference of the negative electrode plate 12 and two straight lines 40a and 40b extending from the winding central axis 29 of the electrode body 14 to two points which are apart outside from the two ends of the inner circumference side negative electrode lead 20a in the circumference direction (that is, winding direction γ) by an angle of 10° with respect to the winding central axis 29 is regarded as the first region A. In the case described above, the “outermost circumference” of the negative electrode plate 12 indicates one turn from a winding finish front end of the negative electrode plate 12 in a winding start direction. In this first region A, it is believed that the electrode plate deformation due to the negative electrode lead 20a is liable to occur. The reason for this is considered that since the negative electrode lead 20a is located at the inner circumference side of the electrode body 14, the internal pressure is increased at the positive electrode plate 11 and the negative electrode plate 12 which are wound at the outer circumference side of the electrode body 14. In addition, the reason the straight lines 40a and 40b extending from the points apart from the two ends of the negative electrode lead 20a in the circumference direction by an angle of 10° are conceived is as follows. That is, when the electrode body 14 is expanded and contracted during charge/discharge, for example, by the variation in pressure acting from the outer circumference side, the position of the negative electrode lead 20a may be slightly changed in the circumference direction, and this slight change in position described above is taken into consideration. Hence, in order to suppress the internal short circuit by the electrode plate deformation due to the negative electrode lead 20a, the winding start front end 11a of the positive electrode plate 11 is preferably not disposed in the first region A defined as described above.

Next, the positive electrode lead 19 will be discussed. In this embodiment, a region defined by two straight lines 42a and 42b in contact with the two ends of the positive electrode lead 19 in the circumference direction each drawn in parallel to a straight line 41 between the center of the positive electrode lead 19 in the circumference direction and the winding central axis 29, the outermost circumference of the negative electrode plate 12, and the innermost circumference thereof is regarded as the second region B. In FIG. 5, the second region B is shown by a dotted line. In the case described above, the “innermost circumference” of the negative electrode plate 12 indicates one turn from a winding start front end of the negative electrode plate 12 in a winding finish direction thereof. The reason the electrode plate deformation due to the positive electrode lead 19 is believed to be liable to occur in this second region B is considered that, since the positive electrode lead 19 having a large thickness and a high rigidity compared to those of the positive electrode collector 30 is provided as shown in FIG. 5, the internal pressure is increased at the inner circumference side and the outer circumference side thereof. In addition, although the first region A defined based on the negative electrode lead 20a has an approximately fan shape, the second region B has a long rectangular shape extending in the radial direction. The reason the shape of the second region B is different from that of the first region A is that since the positive electrode lead 19 is disposed at the intermediate position in the radial direction and is not disposed at the innermost circumference portion unlike the negative electrode lead 20a, it is difficult to believe that a region having a higher internal pressure state is expanded in the circumference direction. Hence, in order to suppress the internal short circuit by the electrode plate deformation due to the positive electrode lead 19, the winding start front end 11a of the positive electrode plate 11 is preferably not disposed in the second region B defined as described above.

As has thus been described, in the radial-direction cross-section of the electrode body 14, the winding start front end 11a of the positive electrode plate 11 is preferably disposed in the region other than the first region A and the second region B. Accordingly, the internal short circuit between the winding start front end 11a of the positive electrode plate 11 and the negative electrode plate 12 due to the positive electrode lead 19 or the negative electrode lead 20a can be effectively suppressed.

### Experimental Examples

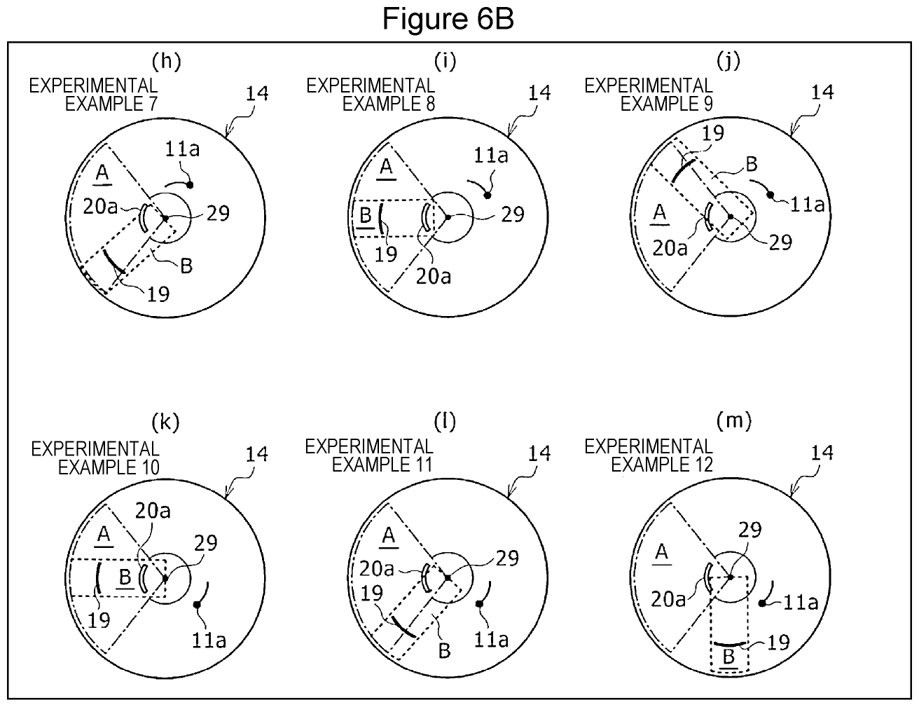

The present inventors of the present disclosure formed 12 types of electrode bodies shown in FIGS. 6A and 6B under the following conditions, performed charge/discharge cycle tests under predetermined conditions, and confirmed the generation of the electrode plate deformation.

[Formation of Positive Electrode Plate]

First, 100 parts by mass of a lithium transition metal oxide represented by LiNi_{0.88}Co_{0.09}Al_{0.03}O₂ as a positive electrode active material, 1 part by mass of acetylene black, and 0.9 parts by mass of poly(vinylidene fluoride) as a binder were mixed together, and an appropriate amount of N-methyl-2-pyrrolidone (NMP) was further added, so that a positive electrode mixture slurry was prepared. Next, this positive electrode mixture slurry was applied on two surfaces of a positive electrode collector formed from aluminum foil, and the coating films thus obtained were dried. After the collector on which the coating films were formed was rolled by rollers and was then cut into a predetermined electrode size, an aluminum-made positive electrode lead was ultrasonic welded to an un-covered portion provided at a longitudinal-direction central portion, so that a positive electrode plate was formed.

[Formation of Negative Electrode Plate]

First, 95 parts by mass of a graphite powder, 5 parts by mass of a silicon oxide, 1 part by mass of a carboxymethyl cellulose (CMC) as a thickening agent, and 1 part by mass of a styrene-butadiene rubber (SBR) as a binder were mixed together, and an appropriate amount of water was further added, so that a negative electrode mixture slurry was prepared. Next, this negative electrode mixture slurry was applied on two surfaces of a negative electrode collector formed from copper foil, and the coating films thus obtained were dried. After the collector on which the coating films were formed was rolled by rollers and was then cut into a predetermined electrode size, negative electrode leads were ultrasonic welded to un-covered portions provided at two longitudinal-direction ends, so that a negative electrode plate was prepared.

[Formation of Electrode Body]

The positive electrode plate and the negative electrode plate were wound with the separators each formed from a polyethylene-made porous film interposed therebetween, and an insulating tape was adhered to the outermost circumference portion, so that the electrode body of each of Experimental Examples 1 to 12 shown in FIGS. 6A and 6B was formed. Those electrode bodies were formed so that the positional relationships among the first region relating to the negative electrode lead, the second region relating to the positive electrode lead, and the winding start front end of the positive electrode plate were changed from each other.

[Preparation of Nonaqueous Electrolyte]

To 100 parts by mass of a mixed solvent containing ethylene carbonate (EC) and dimethyl methyl carbonate (DMC) mixed at a volume ratio of 1:3, 5 parts by mass of vinylene carbonate (VC) was added, and LiPF₆ was then dissolved to have a concentration of 1.5 mol/L, so that a nonaqueous electrolyte solution was prepared.

[Formation of Secondary Battery]

After insulating plates were disposed on the top and the bottom of the electrode body described above, the negative electrode leads of the electrode body were ultrasonic welded to a bottom portion of a case main body, and in addition, after the positive electrode lead of the electrode body was ultrasonic welded to a filter of a sealing body, the electrode body was received in the case main body. Subsequently, the nonaqueous electrolyte solution was charged in the case main body. Finally, an opening portion of the case main body was sealed by the sealing body, so that a nonaqueous electrolyte secondary battery was formed. The capacity of this secondary battery was 4,600 mAh.

[Charge/Discharge Conditions]

In an environment at 25° C., after a constant current charge at 1,380 mA (0.3 hour rate) was performed to a voltage of 4.2 V, a charge/discharge cycle in which a constant voltage charge at 4.2 V to a finish current of 92 mA, a rest for 20 minutes, a constant current discharge at a discharge current of 4,600 mA (one hour rare), and a rest for 20 minutes were performed in this order was repeatedly performed 500 cycles.

[Evaluation]

After the charge/discharge cycle test described above was performed, the position at which the electrode plate deformation of the electrode body occurred was investigated. As a result, in all Experimental Examples 1 to 12, it was confirmed that the electrode plate deformation occurred in at least one region of the first region A and the second region B. Hence, it could be confirmed that when the winding start front end of the positive electrode plate was disposed in a region other than the first and the second regions, the internal short circuit due to the electrode plate deformation could be suppressed.

In addition, the nonaqueous electrolyte secondary battery of the present disclosure is not limited to the above embodiment and the modified examples thereof and, of course, may be variously changed and/or improved within the content described in claims of the present disclosure and within the range equivalent thereto.

### REFERENCE SIGNS LIST

10 nonaqueous electrolyte secondary battery, 11 positive electrode plate, 11a winding start front end, 12 negative electrode plate, 12a electrode plate deformation portion, 13 separator, 14 electrode body, 15 case main body, 16 sealing body, 17 and 18 insulating plate, 19 positive electrode lead, 20a and 20b negative electrode lead, 21 protruding portion, 22 filter, 23 lower valve, 24 insulating member, 25 upper valve, 26 cap, 27 gasket, 28 space, 29 winding central axis, 30 positive electrode collector, 31 positive electrode active material layer, 32, 37a, and 37b un-covered portion, 35 negative electrode collector, 36 negative electrode active material layer, 40a, 40b, 41, 42a, and 42b straight line, A first region, B second region.

1. A nonaqueous electrolyte secondary battery comprising:
an electrode body in which a positive electrode plate having a positive electrode lead and a negative electrode plate having a negative electrode lead are wound in a spiral shape with at least one separator interposed therebetween,
wherein the positive electrode lead is connected to the positive electrode plate at a radial-direction intermediate position of the electrode body, and the negative electrode lead is connected to the negative electrode plate at a winding start end thereof, and
in a radial-direction cross-section of the electrode body, when a region defined by the outermost circumference of the negative electrode plate and two straight lines extending from a winding central axis of the electrode body through two points which are apart outside from two circumference-direction ends of the negative electrode lead by an angle of 10° with respect to the winding central axis is regarded as a first region, and when a region defined by two straight lines in contact with two circumference-direction ends of the positive electrode lead each drawn in parallel to a straight line between a circumference-direction center of the positive electrode lead and the winding central axis, the outermost circumference of the negative electrode plate, and the innermost circumference thereof is regarded as a second region, a winding start front end of the positive electrode plate is disposed in a region other than the first and the second regions.

2. A nonaqueous electrolyte secondary battery according to claim 1, further comprising: another negative electrode lead connected to a winding finish end of the negative electrode plate.
